(19) United States
(12) Patent Application Publication
(10) Pub. No.: US 2021/0116150 A1
(43) Pub. Date: Apr. 22, 2021

(54) LIQUID TEMPERATURE ADJUSTMENT APPARATUS AND TEMPERATURE ADJUSTMENT METHOD USING THE SAME

(71) Applicant: SHINWA CONTROLS CO., LTD, Kawasaki-Shi (JP)

(72) Inventors: Katsuji UCHINO, Kawasaki-Shi (JP); Yasuhiro NAOHARA, Kawasaki-Shi (JP)

(73) Assignee: SHINWA CONTROLS CO., LTD, Kawasaki-Shi (JP)

(21) Appl. No.: 16/755,709

(22) PCT Filed: Oct. 24, 2018
(86) PCT No.: PCT/JP2018/039433

§ 371 Date: Apr. 13, 2020

(30) Foreign Application Priority Data
Oct. 30, 2017 (JP) 2017-209685

(51) Int. Cl. F25B 5/02; B23Q 11/10; B23Q 11/12

(52) U.S. Cl. CPC F25B 5/02; F25B 2700/21; B23Q 11/126; B23Q 11/1069

(57) ABSTRACT

A liquid temperature adjustment apparatus 1 includes: a refrigeration device 10 which includes a refrigeration circuit 16 in which a compressor 11, a condenser 12, a first expansion valve 13, and a first evaporator 14 are connected in this order by a pipe to circulate a heat medium and an injection circuit 17 which branches from a portion downstream of the compressor 11 and upstream of the condenser 12 in the refrigeration circuit 16 and is connected to a portion downstream of the first expansion valve 13 and upstream of the first evaporator 14; and a first liquid supply device 100 which circulates a first liquid. The injection circuit 17 includes a flowrate adjustment valve 17A which adjusts a flowrate of the circulated heat medium. Further, the first liquid circulated by the first liquid supply device 100 is cooled by the first evaporator 14.

### TECHNICAL FIELD

The present invention relates to a liquid temperature adjustment apparatus capable of adjusting a temperature of a liquid by a refrigeration device having a compressor, a condenser, an expansion valve, and an evaporator and supplying the liquid to a temperature adjustment object side, and a temperature adjustment method using the same.

### BACKGROUND ART

A liquid temperature adjustment apparatus is known that includes a refrigeration device including a compressor, a condenser, an expansion valve, and an evaporator, and a circulation device that circulates a liquid such as brine, and cools the liquid in the circulation device by the evaporator of the refrigeration device (for example, JP 2015-14417 A). In this type of liquid temperature adjustment apparatus, the circulation device is usually provided with a heater, and after the liquid is cooled by the evaporator, the liquid is heated by the heater so that the temperature of the circulated liquid can be adjusted to a desired temperature with high accuracy.

### SUMMARY OF INVENTION

### Technical Problem

The above-described liquid temperature adjustment apparatus may include a discharge-type liquid supply device instead of the circulation device (circulation-type liquid supply device). In this type of liquid temperature adjustment apparatus, the liquid circulated by the liquid supply device is cooled by an evaporator, and then the liquid is discharged from the liquid supply device to the temperature adjustment object side. This type of liquid temperature adjustment apparatus may be used, for example, at the time of cleaning a temperature adjustment object simultaneously with temperature adjustment for the temperature adjustment object.

In a liquid temperature adjustment apparatus including such a discharge-type liquid supply device, there is a tendency that a large amount of liquid is discharged from the liquid supply device. As the liquid, tap water, pure water generated from tap water, water stored in a large tank, or the like is used in some cases.

The temperature of tap water changes relatively greatly according to environmental changes, and the temperature of water stored in a large tank also changes relatively greatly according to environmental changes when no temperature adjustment device is attached to the tank. In addition, the temperature of tap water or water stored in a large tank is usually not adjusted before the water is drawn into the liquid supply device. Therefore, in a liquid temperature adjustment apparatus that uses a liquid such as tap water in a discharge-type liquid supply device, a situation can occur in which refrigeration capacity or heating capacity required to adjust the temperature of the liquid to a target temperature varies greatly according to the fluctuation of the temperature of the liquid before the temperature adjustment.

Measures taken when the above situation occurs include the adjustment of the heating capacity of the heater on the liquid supply device side, the adjustment of the opening of the expansion valve on the refrigeration device side, and the adjustment of the rotation speed of the compressor.

However, the adjustment of the heating capacity of the heater lacks quick response, and if it is attempted to output a large heating capacity, the power consumption may become large, and the running cost may increase excessively. In addition, if is attempted to expand the output range of the heating capacity, the manufacturing cost may increase excessively.

On the other hand, in the adjustment of the opening of the expansion valve, the refrigeration capacity cannot be adjusted in a wide range, and it is difficult to sufficiently cope with the case where the temperature fluctuation of the liquid as a temperature adjustment object is large. In addition, the adjustment of the rotation speed of the compressor tends to disturb the behavior of the heat medium after the adjustment of the rotation speed, and the disturbance easily occurs. Thus, it takes time until a stable refrigeration capacity is output, so as to lack quick response.

The invention has been made in consideration of the above circumstances, and an object of the invention is to provide a liquid temperature adjustment apparatus capable of quickly adjusting a temperature of a liquid to a target temperature with high accuracy while suppressing the manufacturing cost and running cost even when the temperature of the liquid to be introduced for temperature adjustment can fluctuate greatly and a temperature adjustment method using the same.

### Solution to Problem

A liquid temperature adjustment apparatus according to the invention includes: a refrigeration device which includes a refrigeration circuit in which a compressor, a condenser, a first expansion valve, and a first evaporator are connected in this order by a pipe to circulate a heat medium and an injection circuit which branches from a portion downstream of the compressor and upstream of the condenser in the refrigeration circuit and is connected to a portion downstream of the first expansion valve and upstream of the first evaporator; and a first liquid supply device which circulates a first liquid, in which the injection circuit includes a flowrate adjustment valve which adjusts a flowrate of the circulated heat medium, and the first liquid circulated by the first liquid supply device is cooled by the first evaporator.

In this liquid temperature adjustment apparatus, the high-temperature heat medium that has flowed out of the compressor can be supplied to a portion downstream of the first expansion valve and upstream of the first evaporator through the injection circuit, and the flowrate of the heat medium supplied at this time can be adjusted by the flowrate adjustment valve. Accordingly, the refrigeration capacity output from the first evaporator can be adjusted in a wide range. In addition, the temperature of the heat medium flowing into the first evaporator can be changed by adjusting the mixing ratio of the high-temperature heat medium to the low-temperature heat medium. The temperature of the heat medium flowing into the first evaporator is quickly raised by increasing the mixing amount of the high-temperature heat medium, and the temperature of the heat medium flowing into the first evaporator is quickly lowered by lowering the mixing amount of the high-temperature heat medium. By adjusting the refrigeration capacity without adjusting the rotation speed of the compressor based on adjusting the temperature of the heat medium as described above, a desired refrigeration capacity can be obtained quickly and accurately. In addition, since the refrigeration capacity is adjusted not by additional power supply but by using a part of the heat medium circulating in the refrigeration circuit, manufacturing cost and running cost can be suppressed. Therefore, even when the temperature of the liquid (first liquid) to be introduced for temperature adjustment can fluctuate greatly, the temperature of the liquid (first liquid) can be quickly adjusted to the target temperature with high accuracy while suppressing the manufacturing cost and running cost.

The first liquid supply device may be a discharge-type liquid supply device that discharges the first liquid supplied from a liquid supply source after temperature adjustment.

The liquid supply source may be water supply, and the first liquid may be tap water, or the liquid supply source may be a tank which stores the first liquid and does not includes a device for adjusting a temperature of the stored first liquid.

In addition, the first liquid may be pure water generated from tap water.

When a discharge-type liquid supply device is used in this type of liquid temperature adjustment apparatus, there is a tendency that a large amount of liquid is discharged from the liquid supply device, and in many cases, the tap water supplied from the water supply or the water stored in a large tank is used as the liquid. At this time, the temperature of tap water or water stored in a large tank is usually not adjusted before being drawn into the liquid supply device. Therefore, in a case where the first liquid supply device is a discharge-type liquid supply device, and further, in a case where the liquid supply source for the first liquid supply device is a tank that does not include a device for adjusting the temperature of water supply or the stored liquid, the liquid temperature adjustment apparatus according to the invention can quickly adjust the temperature of the liquid (first liquid) to the target temperature with high accuracy particularly while effectively suppressing the manufacturing cost and the running cost.

Incidentally, the water supply means a facility that supplies water, and the tap water means water supplied from the water supply. For example, the water supply may be a water supply (waterworks) managed by a national or local public entity, and the tap water may be water supplied from the water supply and purified to meet a specific standard.

In addition, the pure water means high-purity water produced through a cleaning process using an ion exchange resin or the like. Incidentally, when pure water is generated from tap water, the pure water means tap water in a broad sense. Therefore, when the liquid supply source is water supply, and the first liquid is pure water generated from tap water, the pure water means water generated from tap water through a pure water production device.

The refrigeration device further includes a parallel pipe which branches from a portion downstream of the condenser and upstream of the first expansion valve in the refrigeration circuit and is connected to a portion downstream of the first evaporator and upstream of the compressor. A second expansion valve and a second evaporator may be provided in this order in the parallel pipe. The heat medium may circulate in an order of the compressor, the condenser, the second expansion valve, and the second evaporator in the refrigeration device.

In this case, the second evaporator can adjust the temperature of a fluid different from the first liquid, that is, a liquid or gas different from the first liquid. Accordingly, the temperature of a plurality of temperature adjustment objects can be efficiently adjusted using the single refrigeration device.

The liquid temperature adjustment apparatus according to the invention further may include a second liquid supply device which circulates a second liquid. The second liquid circulated by the second liquid supply device may be cooled by the second evaporator.

At this time, the second liquid supply device may be a circulation-type liquid supply device for circulating the second liquid.

In this case, the temperature of two types of liquids can be efficiently adjusted using a single refrigeration device. For example, in a case where a temperature fluctuation becomes large when one liquid is introduced for temperature adjustment, and a temperature fluctuation becomes small when the other liquid is introduced for temperature adjustment, a desired temperature adjustment by two types of liquids can be realized while effectively suppressing the manufacturing cost by cooling the one liquid by the first evaporator and cooling the other liquid by the second evaporator. Incidentally, in this case, an injection circuit for supplying a high-temperature heat medium is not provided between the second expansion valve and the second evaporator.

More specifically, in general, the temperature fluctuation of the liquid circulating after the temperature adjustment of the temperature adjustment object tends to be small in the circulation-type liquid supply device. Thus, in a case where the second liquid supply device is a circulation-type liquid supply device, the second liquid circulated by the second liquid supply device may be cooled by the second evaporator. In this case, the desired temperature adjustment by two types of liquids can be achieved while effectively suppressing the manufacturing cost.

The second liquid supply device may include a heater that heats the second liquid.

In this case, even when a situation occurs in which the high-temperature heat medium is supplied from the injection circuit so that the refrigeration capacity of the second evaporator is reduced with respect to a desired value, a desired temperature adjustment state with respect to the second liquid can be maintained by lowering the heating capacity of the heater so as to compensate for this reduction. Incidentally, in this case, it is necessary to cause the heater to typically output a predetermined heating capacity.

In a temperature adjustment method using a liquid temperature adjustment apparatus according to the invention, the liquid temperature adjustment apparatus includes

a refrigeration device which includes a refrigeration circuit in which a compressor, a condenser, a first expansion valve, and a first evaporator are connected in this order by a pipe to circulate a heat medium and an injection circuit which branches from a portion downstream of the compressor and upstream of the condenser in the refrigeration circuit and is connected to a portion downstream of the first expansion valve and upstream of the first evaporator,

a first liquid supply device which circulates a first liquid, and

a second liquid supply device which circulates a second liquid

The refrigeration device includes a parallel pipe which branches from a portion downstream of the condenser and upstream of the first expansion valve in the refrigeration circuit and is connected to a portion downstream of the first evaporator and upstream of the compressor.

A second expansion valve and a second evaporator are provided in this order in the parallel pipe.

The heat medium circulates in an order of the compressor, the condenser, the second expansion valve, and the second evaporator in the refrigeration device.

The injection circuit includes a flowrate adjustment valve which adjusts a flowrate of the circulated heat medium.

The first liquid supply device is a discharge-type liquid supply device for discharging the first liquid supplied from a liquid supply source after temperature adjustment.

The second liquid supply device is a circulation-type liquid supply device for circulating the second liquid.

The first liquid circulated by the first liquid supply device is cooled by the first evaporator, and the second liquid circulated by the second liquid supply device is cooled by the second evaporator.

The temperature adjustment method includes:

a process of cooling and cleaning a workpiece and a surrounding area thereof cut by a cutting tool with the first liquid cooled by the first evaporator; and

a process of cooling a drive part of the cutting tool with the second liquid cooled by the second evaporator.

According to the temperature adjustment method, economically, the workpiece cut by the cutting tool and the surrounding area thereof can be cooled, and the drive part of the cutting tool can be cooled.

According to the invention described above, even when the temperature of the liquid to be introduced for temperature adjustment can fluctuate greatly, the temperature of the liquid can be quickly adjusted to the target temperature with high accuracy while suppressing the manufacturing cost and running cost.

### BRIEF DESCRIPTION OF DRAWINGS

FIG. 1 is a schematic view of a liquid temperature adjustment apparatus according to a first embodiment of the invention.

FIG. 2 is a schematic view of a liquid temperature adjustment apparatus according to a second embodiment of the invention.

FIG. 3 is a schematic view of a liquid temperature adjustment apparatus according to a third embodiment of the invention.

### DESCRIPTION OF EMBODIMENTS

Hereinafter, embodiments of the invention will be described in detail with reference to the accompanying drawings.

### First Embodiment

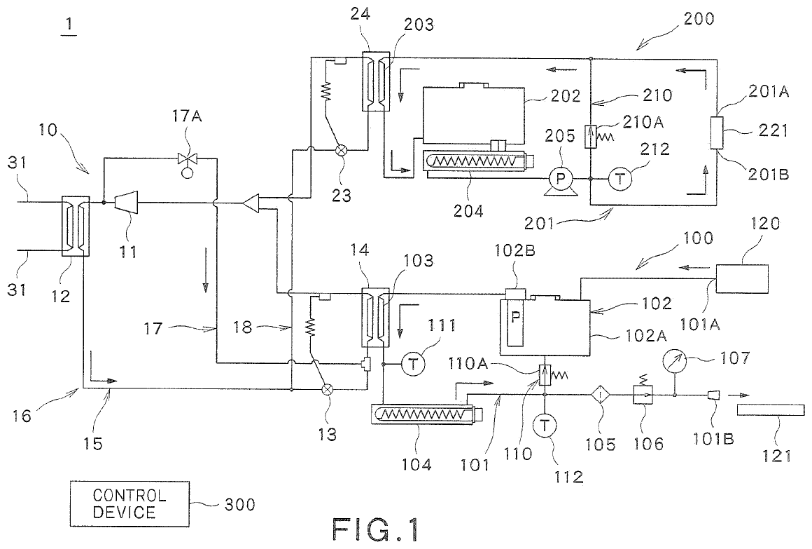

FIG. 1 is a schematic view of a liquid temperature adjustment apparatus 1 according to a first embodiment of the invention. As illustrated in FIG. 1, the liquid temperature adjustment apparatus 1 according to this embodiment includes a heat pump type refrigeration device 10, a first liquid supply device 100 that circulates a first liquid, a second liquid supply device 200 that circulates a second liquid, and a control device 300.

(Refrigeration Device)

The refrigeration device 10 includes a refrigeration circuit 16 in which a compressor 11, a condenser 12, a first expansion valve 13, and a first evaporator 14 are connected in this order by a pipe 15 to circulate a heat medium, an injection circuit 17, and a parallel pipe 18.

The injection circuit 17 branches from a portion downstream of the compressor 11 and upstream of the condenser 12 in the refrigeration circuit 16 and is connected to a portion downstream of the first expansion valve 13 and upstream of the first evaporator 14. The parallel pipe 18 branches from a portion downstream of the condenser 12 and upstream of the first expansion valve 13 in the refrigeration circuit 16, and is connected to a portion downstream of the first evaporator 14 and upstream of the compressor 11.

The parallel pipe 18 is provided with a second expansion valve 23 and a second evaporator 24 in this order. In the refrigeration device 10, the heat medium circulates the compressor 11, the condenser 12, the second expansion valve 23, and the second evaporator 24 in this order.

The compressor 11 compresses the heat medium in a low-temperature and low-pressure gaseous state and supplies the compressed heat medium to the condenser 12 as a high-temperature and high-pressure gas state. The condenser 12 cools and condenses the heat medium compressed by the compressor 11 with cooling water and supplies the heat medium to the first expansion valve 13 and the second expansion valve 23 as a low-temperature and high-pressure liquid state.

As the cooling water for the condenser 12, water may be used, or other refrigerants may be used. FIG. 1 illustrates a cooling water pipe 31 for circulating cooling water to be supplied to the condenser 12 and discharging the cooling water flowing out from the condenser 12. The cooling water in the cooling water pipe 31 is circulated by a pump (not illustrated) and flows into the condenser 12 to exchange heat with the heat medium, thereby cooling the heat medium.

The first expansion valve 13 decompresses the heat medium supplied from the condenser 12 by expanding and supplies the heat medium to the first evaporator 14 as a low-temperature and low-pressure gas-liquid mixed state. The first evaporator 14 cools the first liquid with the heat medium by exchanging heat between the supplied heat medium and the first liquid circulated by the first liquid supply device 100.

The heat medium exchanging heat with the first liquid ideally becomes in a low-temperature and low-pressure gaseous state, flows out of the first evaporator 14, and is compressed again by the compressor 11. In this embodiment, the first expansion valve 13 is a mechanical automatic expansion valve, and the opening of the first expansion valve 13 is automatically adjusted according to the temperature of the heat medium flowing out from the first evaporator 14.

Specifically, the opening of the first expansion valve 13 is automatically adjusted such that liquid back to the compressor 11 is prevented. Incidentally, in this embodiment, the first expansion valve 13 is a mechanical automatic expansion valve, but the first expansion valve 13 may be an electronic expansion valve of which the opening can be arbitrarily adjusted.

On the other hand, the second expansion valve 23 also decompresses the heat medium supplied from the condenser 12 via the parallel pipe 18 by expanding and supplies the heat medium to the second evaporator 24 as a low-temperature and low-pressure gas-liquid mixed state. The second evaporator 24 cools the second liquid with the heat medium by exchanging heat between the supplied heat medium and the second liquid circulated by the second liquid supply device 200.

The heat medium heat-exchanged with the second liquid ideally becomes in a low-temperature and low-pressure gaseous state, flows out of the second evaporator 24, and is compressed again by the compressor 11. In this embodiment, the second expansion valve 23 is also a mechanical automatic expansion valve, and the opening of the second expansion valve 23 is automatically adjusted according to the temperature of the heat medium flowing out from the second evaporator 24.

That is, the opening of the second expansion valve 23 is also automatically adjusted such that liquid back to the compressor 11 is prevented. Incidentally, the second expansion valve 23 may also be an electronic expansion valve of which the opening can be arbitrarily adjusted.

On the other hand, the injection circuit 17 includes a flowrate adjustment valve 17A for adjusting the flowrate of the high-temperature and high-pressure heat medium which is circulated from a portion downstream of the compressor 11 and upstream of the condenser 12 to a portion downstream of the first expansion valve 13 and upstream of the first evaporator 14 in the refrigeration circuit 16.

Accordingly, in the injection circuit 17, by adjusting the opening of the flowrate adjustment valve 17A, the high-temperature and high-pressure gaseous heat medium flowing out of the compressor 11 can be mixed with the low-temperature and low-pressure gas-liquid mixture of heat medium flowing out of the first expansion valve 13 in a flowrate-adjusting manner. Incidentally, the flowrate adjustment valve 17A is an electronic expansion valve, and the opening thereof is adjusted by the control device 300.

(First Liquid Supply Device)

Next, the first liquid supply device 100 will be described. The first liquid supply device 100 is a discharge-type liquid supply device that discharges the first liquid supplied from a liquid supply source 120 after temperature adjustment. The first liquid supply device 100 adjusts the temperature of the first liquid by the first evaporator 14 of the refrigeration device 10 and a heater 104 (to be described later) provided in itself and then discharges the first liquid toward a first temperature adjustment object 121.

The first liquid supply device 100 includes a first side liquid flow path 101 including an upstream end 101A and a downstream end 101B, and the first liquid supply device 100 is configured to receive the first liquid from the liquid supply source 120 at the upstream end 101A and to discharge the first liquid from the downstream end 101B toward the first temperature adjustment object 121.

In the first side liquid flow path 101, in order from the upstream side (liquid supply source 120 side), a pump-integrated tank 102, a cooled part 103 connected to the first evaporator 14, the above-described heater 104, a filter 105, a regulator 106, and a discharge pressure sensor 107 are provided.

The pump-integrated tank 102 has a tank main body 102A for storing the first liquid, and an immersion type pump 102B provided in the tank main body 102A. By driving the pump 102B, the first liquid is drawn into the tank main body 102A from the liquid supply source 120, and the first liquid stored in the tank main body 102A is circulated to the cooled part 103 side.

Incidentally, in this embodiment, the pump 102B is an immersion type in which the pump 102B is disposed in the tank main body 102A. However, the pump 102B may be a non-immersion type pump provided in the middle of the pipe configuring the first side liquid flow path 101.

The cooled part 103 is connected to the first evaporator 14, and the first liquid is cooled by the first evaporator 14 when circulating through the cooled part 103. Here, the first evaporator 14 in this embodiment is configured by a heat exchanger of a type capable of circulating two different types of fluids and specifically is configured by a plate type heat exchanger.

In this case, the first evaporator 14 is provided with two types of flow paths through which two types of fluid can circulate. The heat medium circulates through one flow path, and the first liquid circulates through the other flow path. When the description is given strictly, the cooled part 103 referred to in this embodiment corresponds to the other flow path in the first evaporator 14 through which the first liquid circulates.

Subsequently, for example, the heater 104 is an electric heater and can heat the first liquid circulating in the heater 104. The heating capacity of the heater 104 is adjusted by the control device 300.

In addition, the filter 105 is provided for capturing foreign matters contained in the first liquid. The regulator 106 is provided for maintaining the pressure of the first liquid discharged from the downstream end 101E at a constant value, and the discharge pressure sensor 107 is provided for detecting the pressure of the first liquid that has passed through the regulator 106.

As an example, the liquid temperature adjustment apparatus 1 according to this embodiment is assumed to be used under the condition that the liquid supply source 120 is water supply, the first liquid is tap water, strictly, pure water generated from tap water, the first temperature adjustment object 121 is a workpiece to be subjected to precision machining, and the workpiece and the surrounding area thereof are temperature-adjusted and washed with pure water.

In this case, when the first liquid contains foreign matters or the pressure of the first liquid supplied to the workpiece becomes higher than a predetermined pressure, the machining accuracy of the workpiece subjected to precision machining may be reduced. Therefore, in this embodiment, the above-described filter 105, the regulator 106, and the discharge pressure sensor 107 are provided.

Incidentally, the discharge pressure sensor 107 may transmit information on the detected pressure of the first liquid to the control device 300. In this case, the control device 300 may notify a warning when the detected pressure is out of the allowable range.

The first liquid supply device 100 according to this embodiment includes a first side bypass flow path 110 which branches from a portion downstream of the heater 104 and upstream of the filter 105 in the first side liquid flow path 101 and is connected to the tank main body 102A of the pump-integrated tank 102. The first side bypass flow path 110 is provided with a relief valve 110A that opens and closes according to the pressure of the first liquid.

When the regulator 106 is operated to maintain the pressure of the first liquid at a constant value, the pressure of the first liquid on the upstream side of the regulator 106 may increase. In this case, in this embodiment, when the relief valve 110A is opened so that the first liquid flows into the tank main body 102A, the pressure of the first liquid on the upstream side of the regulator 106 decreases to be adjusted to a desired state. Accordingly, the operation of the regulator 106 is stabilized, and the pressure of the discharged first liquid is further stabilized.

The first liquid supply device 100 in this embodiment includes a refrigeration control temperature sensor 111 which detects the temperature of the first liquid circulating on the downstream side of the cooled part 103 and the upstream side of the heater 104 in the first side liquid flow path 101 and a first side heating control temperature sensor 112 which detects the temperature of the first liquid circulating on the downstream side of the heater 104 and the upstream side of the filter 105 in the first side liquid flow path 101.

The refrigeration control temperature sensor 111 and the first side heating control temperature sensor 112 transmit the detected temperature of the first liquid to the control device 300.

(Second Liquid Supply Device)

Next, the second liquid supply device 200 will be described. The second liquid supply device 200 is a circulation-type liquid supply device that circulates the second liquid. The second liquid supply device 200 adjusts the temperature of the second liquid by the second evaporator 24 of the refrigeration device 10 and a heater 204 (to be described later) provided in itself and then supplies the second liquid to a second temperature adjustment object 221 side.

The second liquid supply device 200 includes a second side liquid flow path 201 including an upstream end 201A and a downstream end 201B, and each of the upstream end 201A and the downstream end 201B is directly connected to the second temperature adjustment object 221 to circulate the second liquid.

The second side liquid flow path 201 is provided with a cooled part 203 connected to the second evaporator 24, a tank 202, and the heater 204 and a pump 205 described above. When the pump 205 is driven, the second liquid circulates in the order of the cooled part 203, the tank 202, the heater 204, and the pump 205 to flow out of the pump 205, and then is supplied to the second temperature adjustment object 221 side.

The cooled part 203 is connected to the second evaporator 24, and the second liquid is cooled by the second evaporator 24 when circulating through the cooled part 203. Here, the second evaporator 24 in this embodiment is configured by a heat exchanger of a type capable of circulating two different kinds of fluids and specifically is configured by a plate type heat exchanger.

In this case, the second evaporator 24 is provided with two types of flow paths through which two types of fluid can circulate. The heat medium circulates through one flow path, and the second liquid circulates through the other flow path. When the description is given strictly, the cooled part 203 referred to in this embodiment corresponds to the other flow path in the second evaporator 24 through which the second liquid circulates.

Subsequently, the tank 202 stores the second liquid flowing out from the cooled part 203 and communicates with the heater 204. For example, the heater 204 is an electric heater and can heat the second liquid which flows out of the tank 202 to circulate therein. The heating capacity of the heater 204 is adjusted by the control device 300.

The pump 205 is a non-immersion type and is provided in the middle of the pipe configuring the second side liquid flow path 201. Incidentally, in this embodiment, the pump 205 is provided on the downstream side of the heater 204 and on the upstream side of the downstream end 201B. However, the arrangement position of the pump 205 is not particularly limited.

Here, in this embodiment, as described above, the liquid temperature adjustment apparatus 1 according to this embodiment is assumed to be used under the condition that the liquid supply source 120 is water supply, the first liquid is pure water, and the first temperature adjustment object 121 is a workpiece to be subjected to precision machining, and the workpiece and the surrounding area thereof are temperature-adjusted and washed with pure water. In this case, the second liquid supply device 200 is assumed to be used for cooling a drive part (motor or the like) of a cutting tool that processes the workpiece.

In this case, the single liquid temperature adjustment apparatus 1 can economically cool the workpiece cut by the cutting tool and the surrounding area thereof and cool the drive part of the cutting tool.

Incidentally, in this embodiment, the upstream end 201A and the downstream end 201B are directly connected to the second temperature adjustment object 221. However, the upstream end 201A and the downstream end 201B may be indirectly connected to the second temperature adjustment object 221 via a separate pipe. Alternatively, the upstream end 201A and the downstream end 201B may be connected to a temperature adjustment part included in the second liquid supply device 200 to adjust the temperature of the second temperature adjustment object 221 separate from the liquid temperature adjustment apparatus 1 via the temperature adjustment part.

The second liquid supply device 200 according to this embodiment includes a second side bypass flow path 210 which branches from a portion downstream portion of the pump 205 and upstream of the downstream end 201B in the second side liquid flow path 201 and is connected to a portion downstream of the upstream end 201A and upstream of the cooled part 203. The second side bypass flow path 210 is provided with a relief valve 210A that opens and closes according to the pressure of the second liquid.

In this embodiment, when the pressure of the second liquid flowing out from the pump 205 increases, the relief valve 210A is opened so that the second liquid flows to a portion downstream of the upstream end 201A and upstream of the cooled part 203 in the second side liquid flow path 201. Accordingly, the pressure of the second liquid is adjusted to a desired state.

The second liquid supply device 200 in this embodiment includes a second side heating control temperature sensor 212 which detects the temperature of the second liquid circulating on the downstream side of the pump 205 and the upstream side of the downstream end 201B in the second side liquid flow path 201. The second side heating control temperature sensor 212 transmits the detected temperature of the second liquid to the control device 300.

(Control Device)

Next, the control device 300 will be described. The control device 300 is electrically connected to the refrigeration control temperature sensor 111, the first side heating control temperature sensor 112, and the second side heating control temperature sensor 212 described above and is electrically connected to the flowrate adjustment valve 17A, the heater 104, and the heater 204.

The control device 300 adjusts the opening of the flowrate adjustment valve 17A according to the difference between the temperature of the first liquid detected by the refrigeration control temperature sensor 111 and a preset post-cooling target temperature of the first liquid, so as to adjust the flowrate of the high-temperature heat medium to be supplied to a potion downstream of the first expansion valve 13 and upstream of the first evaporator 14. Thereby, the first evaporator 14 can obtain a refrigeration capacity for adjusting the temperature of the first liquid detected by the refrigeration control temperature sensor 111 to the post-cooling target temperature.

In the control device 300, the heating capacity of the heater 104 is adjusted according to a difference between the temperature of the first liquid detected by the first side heating control temperature sensor 112 and a preset target temperature of the first liquid after heating. Thereby, the first liquid having a desired temperature can be supplied to the first temperature adjustment object 121.

In the control device 300, the heating capacity of the heater 204 is adjusted according to a difference between the temperature of the second liquid detected by the second side heating control temperature sensor 212 and a preset target temperature of the second liquid after heating. Thereby, the second liquid having a desired temperature can be supplied to the second temperature adjustment object 221.

(Operation)

Next, the operation of the liquid temperature adjustment apparatus 1 according to this embodiment will be described.

When starting the temperature adjustment operation by the liquid temperature adjustment apparatus 1, first, the compressor 11. of the refrigeration device 10 is driven, the pump 102B of the first liquid supply device 100 is driven, and the pump 205 of the second liquid supply device 200 is driven.

Accordingly, in the refrigeration device 10, the heat medium circulates. In the first liquid supply device 100, the first liquid is drawn into the tank main body 102A from the liquid supply source 120, and the first liquid stored in the tank main body 102A is circulated to the cooled part 103 side to be discharged toward the first temperature adjustment object 121. In addition, in the second liquid supply device 200, the second liquid circulates in the order of the cooled part 203, the tank 202, the heater 204, and the pump 205 to flow out of the pump 205, and then is supplied to the second temperature adjustment object 221 side. Thereafter, the second liquid circulates to the cooled part 203.

When each device 10, 100, 200 is operated as described above, in the refrigeration device 10, the heat medium condensed by the condenser 12 branches and flows into the first expansion valve 13 and the second expansion valve 23. The branched heat mediums are expanded to be in a low-temperature and low-pressure gas-liquid mixed state and flow into the first evaporator 14 and the second evaporator 24.

Then, the first evaporator 14 cools the first liquid with the heat medium by exchanging heat between the supplied heat medium and the first liquid circulated by the first liquid supply device 100. The second evaporator 24 cools the second liquid with the heat medium by exchanging heat between the supplied heat medium and the second liquid circulated by the second liquid supply device 200.

Here, in this embodiment, in the injection circuit 17, by adjusting the opening of the flowrate adjustment valve 17A, the high-temperature and high-pressure gaseous heat medium flowing out of the compressor 11 can be mixed with the low-temperature and low-pressure gas-liquid mixture of heat medium flowing out of the first expansion valve 13 in a flowrate-adjusting manner. Accordingly, for example, even when the first liquid flowing into the cooled part 103 largely fluctuates due to the temperature fluctuation of the first liquid in the liquid supply source 120, the refrigeration capacity of the first evaporator 14 for adjusting the first liquid to a desired temperature can be obtained quickly by switching whether or not to cause the high-temperature and high-pressure heat medium to flow or by adjusting the inflow amount of the heat medium. Accordingly, the temperature of the first liquid can be adjusted to a desired temperature, and the first liquid can be quickly supplied to the first temperature adjustment object 121.

As described above, in this embodiment, the high-temperature heat medium that has flowed out of the compressor 11 can be supplied to a portion downstream of the first expansion valve 13 and upstream of the first evaporator 14 through the injection circuit 17, and the flowrate of the heat medium supplied at this time can be adjusted by the flowrate adjustment valve 17A. Accordingly, the refrigeration capacity output from the first evaporator 14 can be adjusted in a wide range. In addition, the temperature of the heat medium flowing into the first evaporator 14 can be changed by adjusting the mixing ratio of the high-temperature heat medium to the low-temperature heat medium. The temperature of the heat medium flowing into the first evaporator 14 is quickly raised by increasing the mixing amount of the high-temperature heat medium, and the temperature of the heat medium flowing into the first evaporator 14 is quickly lowered by lowering the mixing amount of the high-temperature heat medium. By adjusting the refrigeration capacity without adjusting the rotation speed of the compressor 11 by adjusting the temperature of the heat medium, a desired refrigeration capacity can be obtained quickly and accurately. In addition, since the refrigeration capacity is adjusted not by additional power supply but by using a part of the heat medium circulating in the refrigeration circuit 16, manufacturing cost and running cost can be suppressed.

Therefore, even when the temperature of the liquid (first liquid) to be introduced for temperature adjustment can fluctuate greatly, the temperature of the liquid (first liquid) can be quickly adjusted to the target temperature with high accuracy while suppressing the manufacturing cost and running cost. Specifically, for example, in a case where the temperature fluctuation range of the first liquid is 15° C. to 30° C., and it is required to adjust the temperature of the first liquid to a target temperature in the range of 20° C. to 27° C., the liquid temperature adjustment apparatus 1 according to this embodiment can be used effectively.

In this embodiment, the first liquid supply device 100 is a discharge-type liquid supply device that discharges the first liquid supplied from the liquid supply source 120 after temperature adjustment. In addition, the liquid temperature adjustment apparatus 1 according to this embodiment is assumed to be used under the usage condition that the liquid supply source 120 is water supply, and the first liquid is tap water, particularly, pure water generated from tap water.

When a discharge-type liquid supply device is used in this type of liquid temperature adjustment apparatus, there is a tendency that a large amount of liquid is discharged from the liquid supply device, and in many cases, the tap water supplied from the water supply or the water stored in a large tank is used as the liquid. At this time, the temperature of tap water or water stored in a large tank is usually not adjusted before being drawn into the liquid supply device. Therefore, when the liquid temperature adjustment apparatus 1 according to this embodiment is used under the assumed usage condition described above, the temperature of the first liquid can be quickly adjusted to the target temperature with high accuracy particularly while effectively suppressing the manufacturing cost and the running cost. Incidentally, the liquid temperature adjustment apparatus 1 according to this embodiment can also be usefully used even when the liquid supply source 120 is a tank that does not include a device for adjusting the temperature of the first liquid.

The refrigeration device 10 further includes the parallel pipe 18 which branches from a portion downstream of the condenser 12 and upstream of the first expansion valve 13 in the refrigeration circuit 16 and is connected to a portion downstream of the first evaporator 14 and upstream of the compressor 11. The parallel pipe 18 is provided with a second expansion valve 23 and a second evaporator 24 in this order. Accordingly, the second evaporator 24 can adjust the temperature of a fluid different from the first liquid, that is, a liquid or gas different from the first liquid. Accordingly, the temperature of a plurality of temperature adjustment objects can be efficiently adjusted using the single refrigeration device 10.

In particular, in this embodiment, the liquid temperature adjustment apparatus 1 includes the second liquid supply device 200 that circulates the second liquid, and the second evaporator 24 cools the second liquid. Accordingly, the temperature of two types of liquids can be efficiently adjusted using the single refrigeration device 10.

Specifically, in this embodiment, it is assumed that the first liquid circulated by the first liquid supply device 100 has a large temperature fluctuation when the first liquid is introduced for temperature adjustment, and it is assumed that the second liquid supply device 200 is a circulation type, and the temperature fluctuation of the second liquid circulating after the temperature adjustment of the temperature adjustment object tends to be small. For this reason, when the first liquid is cooled by the first evaporator 14 and the second liquid is cooled by the second evaporator 24, the desired temperature adjustment by two types of liquids can be realized while effectively suppressing the manufacturing cost.

The second liquid supply device 200 in this embodiment includes a heater 204 that heats the second liquid. Accordingly, even when a situation occurs in which the high-temperature heat medium is supplied from the injection circuit 17 so that the refrigeration capacity of the second evaporator 24 is reduced with respect to a desired value, a desired temperature adjustment state with respect to the second liquid can be maintained by lowering the heating capacity of the heater 204 so as to compensate for this reduction. Incidentally, in order to realize such control, it is necessary to cause the heater 204 to typically output a predetermined heating capacity.

### Second Embodiment

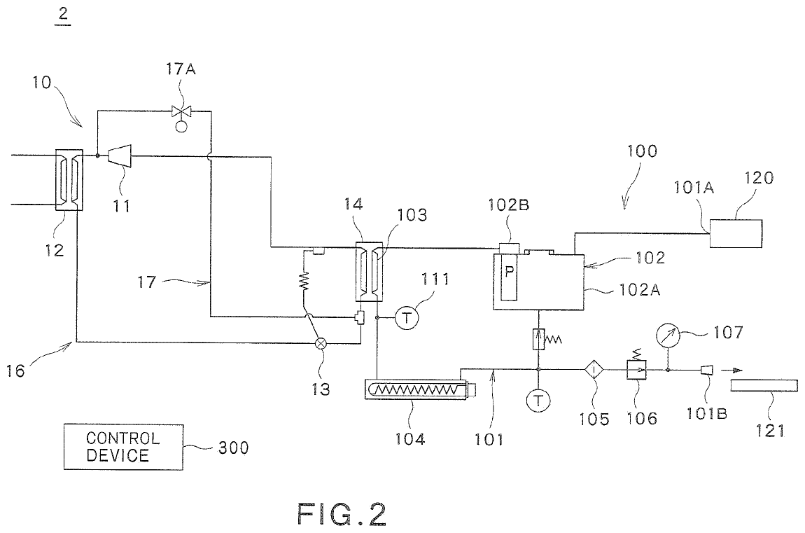

Next, a second embodiment will be described with reference to FIG. 2. Among the components in this embodiment, the same parts as those in the first embodiment are denoted by the same reference numerals, and the description thereof is omitted.

As illustrated in FIG. 2, a liquid temperature adjustment apparatus 2 according to the second embodiment does not includes the parallel pipe 18, the second expansion valve 23, and the second evaporator 24 described in the first embodiment.

### Third Embodiment

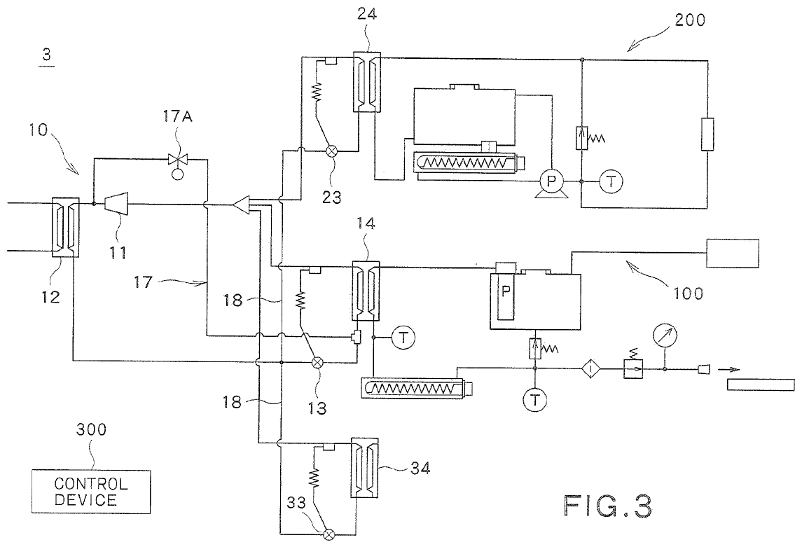

Next, a third embodiment will be described with reference to FIG. 3. Among the components in this embodiment, the same parts as those in the first and second embodiments are denoted by the same reference numerals, and the description thereof is omitted.

As illustrated in FIG. 3, a liquid temperature adjustment apparatus 3 according to the third embodiment includes a plurality of, specifically two, parallel pipes 18 described in the first embodiment. The second expansion valve 23 and the second evaporator 24 are provided in one parallel pipe 18, and a third expansion valve 33 and a third evaporator 34 are provided in the other parallel pipe 18. Incidentally, the number of evaporators provided in parallel to the first evaporator 14 may be four or more.

1. A liquid temperature adjustment apparatus comprising:
a refrigeration device which includes a refrigeration circuit in which a compressor, a condenser, a first expansion valve, and a first evaporator are connected in this order by a pipe to circulate a heat medium and an injection circuit which branches from a portion downstream of the compressor and upstream of the condenser in the refrigeration circuit and is connected to a portion downstream of the first expansion valve and upstream of the first evaporator;
a first liquid supply device which circulates a first liquid; and
a second liquid supply device which circulates a second liquid, wherein the refrigeration device further includes a parallel pipe which branches from a portion downstream of the condenser and upstream of the first expansion valve in the refrigeration and is connected to a portion downstream of the first evaporator and upstream of the compressor,
a second expansion valve and a second evaporator are provided in this order in the parallel pipe,
the heat medium circulates in an order of the compressor, the condenser, the second expansion valve, and the second evaporator in the refrigeration device,
the injection circuit includes a flowrate adjustment valve which adjusts a flowrate of the circulated heat medium,
the first liquid supply device is a discharge-type liquid supply device for discharging the first liquid supplied from a liquid supply source after temperature adjustment,
the second liquid supply device is a circulation-type liquid supply device for circulating the second liquid, and
the first liquid circulated by the first liquid supply device is cooled by the first evaporator, the second liquid circulated by the second liquid supply device is cooled by the second evaporator.

2. (canceled)

3. The liquid temperature adjustment apparatus according to claim 1, wherein the liquid supply source is water supply, and the first liquid is tap water, or the liquid supply source is a tank which stores the first liquid and does not include a device for adjusting a temperature of the stored first liquid.

4. The liquid temperature adjustment apparatus according to claim 3, wherein the first liquid is pure water generated from tap water.

5. (canceled)

6. (canceled)

7. (canceled)

8. The liquid temperature adjustment apparatus according to claim 1, wherein the second liquid supply device includes a heater for heating the second liquid.

9. A temperature adjustment method using a liquid temperature adjustment apparatus, wherein
the liquid temperature adjustment apparatus includes
a refrigeration device which includes a refrigeration circuit in which a compressor, a condenser, a first expansion valve, and a first evaporator are connected in this order by a pipe to circulate a heat medium and an injection circuit which branches from a portion downstream of the compressor and upstream of the condenser in the refrigeration circuit and is connected to a portion downstream of the first expansion valve and upstream of the first evaporator,
a first liquid supply device which circulates a first liquid, and
a second liquid supply device which circulates a second liquid,
the refrigeration device includes a parallel pipe which branches from a portion downstream of the condenser and upstream of the first expansion valve in the refrigeration circuit and is connected to a portion downstream of the first evaporator and upstream of the compressor,
a second expansion valve and a second evaporator are provided in this order in the parallel pipe,
the heat medium circulates in an order of the compressor, the condenser, the second expansion valve, and the second evaporator in the refrigeration device,
the injection circuit includes a flowrate adjustment valve which adjusts a flowrate of the circulated heat medium,
the first liquid supply device is a discharge-type liquid supply device for discharging the first liquid supplied from a liquid supply source after temperature adjustment,
the second liquid supply device is a circulation-type liquid supply device for circulating the second liquid, and
the first liquid circulated by the first liquid supply device is cooled by the first evaporator, and the second liquid circulated by the second liquid supply device is cooled by the second evaporator, the method comprising:
a process of cooling and cleaning a workpiece and a surrounding area thereof cut by a cutting tool with the first liquid cooled by the first evaporator; and
a process of cooling a drive part of the cutting tool with the second liquid cooled by the second evaporator.

10. The liquid temperature adjustment apparatus according to claim 1, wherein the parallel pipe does not include an injection circuit which branches from a portion downstream of the compressor and upstream of the condenser in the refrigeration circuit and is connected to a portion downstream of the second expansion valve and upstream of the second evaporator of the parallel pipe.

11. The liquid temperature adjustment apparatus according to claim 1, wherein the first liquid supply device includes a filter for capturing foreign matters contained in the first liquid and a regulator for maintaining the pressure of the first liquid.

12. The liquid temperature adjustment apparatus according to claim 11, wherein the first liquid supply device further include a tank which is disposed upstream of the filter and the regulator, a bypass flow path which branches from a portion downstream of the tank and upstream of the filter and the regulator and is connected to the tank, and a relief valve on the bypass flow path.

13. The liquid temperature adjustment method according to claim 9, wherein the liquid supply source is water supply, and the first liquid is tap water, or the liquid supply source is a tank which stores the first liquid and does not includes a device for adjusting a temperature of the stored first liquid.

14. The liquid temperature adjustment method according to claim 13, wherein the first liquid is pure water generated from tap water.
